(19) United States
(12) Patent Application Publication
(10) Pub. No.: US 2002/0093567 A1
(43) Pub. Date: Jul. 18, 2002

(54) Method and system for generating a digital photographic proof

(75) Inventors: Daryl Carvis Cromer, Apex, NC (US); David Carroll Challener, Raleigh, NC (US); Richard Alan Dayan, Wake Forest, NC (US); Dhruv Manmohandas Desai, Cary, NC (US); Howard Jeffrey Locker, Cary, NC (US); Andy Lloyd Trotter, Raleigh, NC (US); James Peter Ward, Raleigh, NC (US)

Correspondence Address: Andrew J. Dillon, FELSMAN, BRADLEY, VADEN, GUNTER & DILLON, LLP, Lakewood on the Park, Suite 350, 7600B North Capital of Texas Highway, Austin, TX, 78731, US

(73) Assignee: International Business Machines Corporation

(21) Appl. No.: 09/759,951

(22) Filed: Jan. 12, 2001

(51) Int. Cl. H04N 5/225; H04N 7/00

(52) U.S. Cl. 348/207; 348/552; 348/222

(57) ABSTRACT

A method and system are disclosed for generating and distributing a digital photographic proof. An altered image is generated by altering original image data to produce altered image data. The altered image data is stored in an electronic file. The encrypted instructions are stored in the file with the altered image data. The instructions describe a method for reversing an alteration method utilized to alter the original image to produce the altered image data. A digital photographic proof is produced utilizing the file by displaying the altered image. All users are permitted to view the altered image. Only authorized users are permitted to utilize the encrypted instructions to reproduce the original image from the altered image data. Only authorized users may reproduce the original image. The single electronic file is thus utilized to both produce a digital photographic proof and to reproduce the original image.

### BACKGROUND OF THE INVENTION

1. Field of the Invention

The present invention relates in general to digital images, and, in particular, to a method and system for generating a digital photographic proof. Still more particularly, the present invention relates to a method and system for producing a digital photographic proof from an electronic file containing altered image data and encrypted instructions describing a method for reversing the alteration of the altered data in order to reproduce original image data.

2. Description of the Related Art

Digital cameras are known in the art. Digital cameras capture visual images, digitize the captured image, and store the digitized image within the camera in a digital format.

Photographers need the ability to provide a test print of an image to potential buyers without the fear that the test print will be misused. The test print is called a “proof”. Traditionally, the photographer provided a proof to a potential buyer by developing a print from the negative and marking the print in a destructive manner by adding the word “proof” to the photograph. Alternatively, a photographer might use photographic paper which indicated that the photograph was a proof and which included a copyright notice. Professional film developers typically respected the owner's rights in the photograph and refused to reproduce proofs. Further, it is difficult to completely remove a “proof” symbol from a traditional photograph. Therefore, using conventional cameras and film developing techniques, it is difficult to make a high quality reproduction of a photographic proof.

If after viewing the proof the potential buyer decided to purchase the photograph, the photographer could make a high quality reproduction by producing another photograph from the negative without adding a “proof” symbol. Therefore, with conventional analog cameras, a photographer could easily retain the means to produce the highest possible quality photographic print by retaining the negative of the image.

When a digital camera is used, however, it becomes very difficult for a photographer to control the ownership of a captured image. Captured images are stored in a digital format. Distribution of digital images then becomes very easy. A photographer could provide a digital file, such as by providing a floppy diskette, to a potential buyer which contains the captured image. However, the photographer does not have a means for providing a proof image. Although the photographer could add data to the image, it is easy for a user to remove the data. Alteration of these images is easily accomplished even by the most novice of users.

Known systems have recognized this problem. One approach offered to solve this problem is to provide two separate images to a potential buyer. One image is a proof image which is a lower quality image and which is viewable by all users. The other image is a high quality image. The high quality image is encrypted so that it cannot be viewed or printed. After the potential buyer has paid for the right to reproduce the high quality image, the owner of the image can provide a decryption key to decrypt the encrypted high quality image. The decryption key is provided and distributed electronically, for example using a floppy diskette, separately from the encrypted image.

This solution requires that the photographer provide two separate images. One image is a proof and the other image is the encrypted original image. Further, the photographer must be contacted and must provide the decryption key when payment has been made.

Therefore a need exists for a method and system for generating a digital photographic proof to permit a user to view and evaluate an altered image prior to purchasing the high quality original image.

### SUMMARY OF THE INVENTION

A method and system are disclosed for generating and distributing a digital photographic proof. An altered image is generated by altering original image data to produce altered image data. The altered image data is stored in an electronic file. The encrypted instructions are stored in the file with the altered image data. The instructions describe a method for reversing an alteration method utilized to alter the original image to produce the altered image data. A digital photographic proof is produced utilizing the file by displaying the altered image. All users are permitted to view the altered image. Only authorized users are permitted to utilize the encrypted instructions to reproduce the original image from the altered image data. Only authorized users may reproduce the original image. The single electronic file is utilized to both produce a digital photographic proof and to reproduce the original image.

The above as well as additional objectives, features, and advantages of the present invention will become apparent in the following detailed written description.

### BRIEF DESCRIPTION OF THE DRAWINGS

The novel features are set forth in the appended claims. The present invention itself, however, as well as a preferred mode of use, further objectives, and advantages thereof, will best be understood by reference to the following detailed description of a preferred embodiment when read in conjunction with the accompanying drawings, wherein:

FIG. 1 depicts a detailed pictorial representation of a digital camera of in accordance with the method and system of the present invention;

FIG. 2 illustrates a block diagram of a digital camera in accordance with the method and system of the present invention;

FIG. 3 depicts a high level flow chart which illustrates embedding a method in an altered image describing how to reverse the alteration method used to alter the image in accordance with the method and system of the present invention; and

FIG. 4 illustrates a high level flow chart which depicts reproducing original images from the digital proof for only authorized users in accordance with the method and system of the present invention.

### DETAILED DESCRIPTION OF A PREFERRED EMBODIMENT

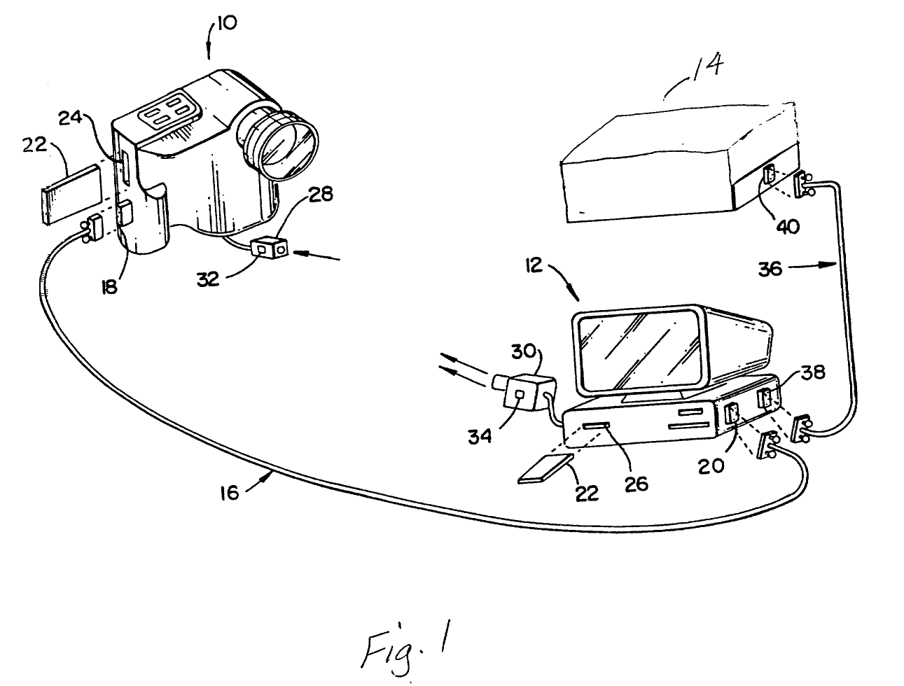

A preferred embodiment of the present invention and its advantages are better understood by referring to FIGS. 1-4 of the drawings, like numerals being used for like and corresponding parts of the accompanying drawings.

The present invention is a method and system for generating and distributing a digital photographic proof. An original image is captured utilizing a digital camera. The original image is represented by original image data which is stored either within the camera or made available to the photographer outside of the camera. The photographer may choose to generate and distribute a digital proof of the original image to potential buyers.

The photographer may generate a digital proof by first choosing an alteration method to use to alter the original image data. Known systems for altering digital photographic data include modifying the image color, shaping random pixels, or modifying all or part of the image using an encryption key. The photographer will then alter the original image data using the chosen alteration method to create altered image data.

The photographer may then generate instructions which will provide a user with a method for reversing the chosen alteration method. Any user who has access to the instructions should be able to reverse the alteration method so that an original image may be reproduced from the altered image data by following the instructions. The instructions will provide a user with all of the information necessary to reverse the chosen alteration method.

Once the instructions are generated, the photographer will encrypt the instructions using a known encryption method. Known encryption methods include symmetric keys, key pairs utilizing certificates, or smart cards. A decryption key is generated which is capable of decrypting the encrypted instructions.

The altered image data and the encrypted instructions are then stored by the photographer as a single, electronic file. This file may be freely transmitted to potential buyers without fear of misuse or theft of the original image data. The file may be transmitted wirelessly, such as over the Internet or by storing the file on floppy diskettes.

A digital photographic proof may be produced from the file which contains the altered data and the encrypted instructions. All users are permitted to view an altered image produced from the altered data.

When a potential buyer has purchased the right to reproduce the original image data, the photographer will provide the decryption key to the buyer. The buyer will then be able to use the decryption key to decrypt the instructions and reproduce the original image from the altered image data. In this manner, the original image is reproduced from the same file which produced the digital proof. Further, the file which was used to produce both the digital proof and to reproduce the original image includes instructions describing how to reproduce the original image from that file.

In this manner, only a single file needs to be distributed to potential buyers. Proofs may be produced from the altered image data stored in the file. When a potential buyer has purchased the right to reproduce the original image, the potential buyer will be capable of reproducing the original image from the altered image data in the single file. In the present invention, there is no need to distribute two separate image files.

FIG. 1 illustrates a pictorial representation of a digital camera in accordance with the method and system of the present invention. A digital camera 10 is depicted coupled to a computer system 12 and a peripheral device such as a printer 14. A variety of means of communication between camera 10 and computer system 12 are shown including a cable assembly 16 interconnecting the camera 10 and computer system 12 through connectors 18 and 20. Communication can also be accomplished through use of a card 22, such as a PCMCIA card for use with card/disk slots 24, 26. Radiated signals can also be used for communication as indicated by transceivers 28, 30. In addition, information can also be transferred through connections 32, 34 to a modem for transmission through a telephone system. Computer system 12 is shown interconnected with the printer 14 by way of cable assembly 36 and connectors 38, 40.

Camera 10 is utilized to capture and store a visual image. The original visual image is initially stored in camera 10. The original image may be transmitted from camera 10 to another device, such as computer system 12 and may be printed utilizing printer 14.

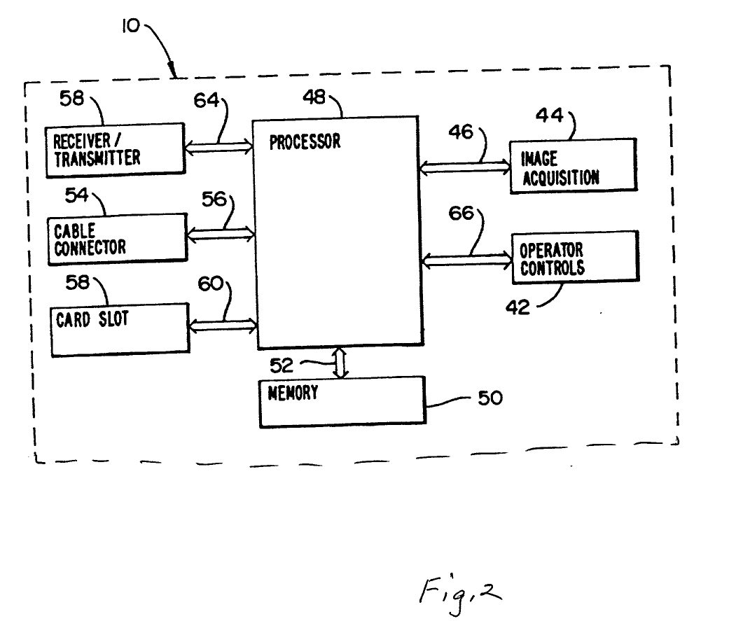

FIG. 2 depicts a more detailed pictorial representation of the digital camera of FIG. 1 in accordance with the method and system of the present invention. Digital camera 10 includes an image acquisition apparatus 44 in communication through bus 46 with a processor 48. The processor by way of bus 52, stores data in memory 50, which also includes ROM memory for basic operations. Input and output of data is through one of the various means described above, including cable connector 54 through bus 56, card/disk slot 58 through bus 60, transceiver 58 by way of bus 64, or modem connection. Controls 42 are shown connected to the processor by way of bus 66.

The image acquisition apparatus 44 includes components well known to those skilled in the art and need not be shown in detail in order to practice the invention. The acquisition apparatus 44 includes an image optical pickup, such as a charged coupled device (CCD) and A/D circuitry to convert the analog CCD signals to digital form for processor 48.

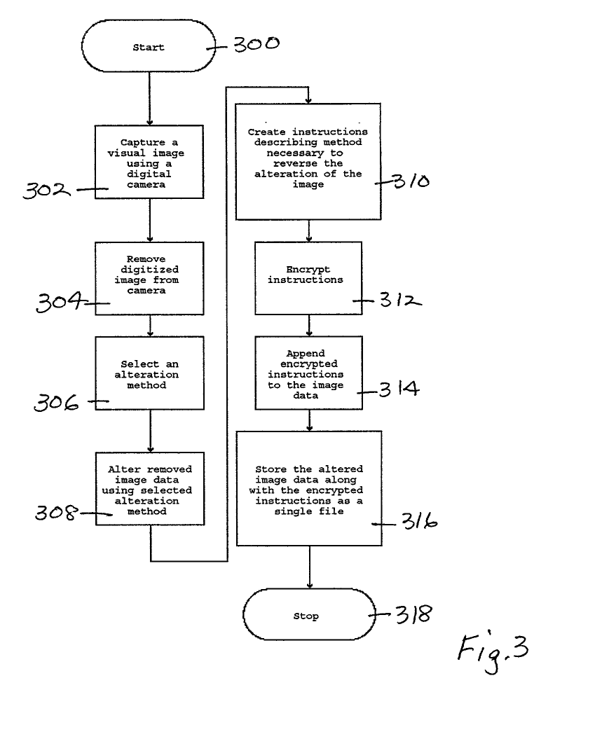

FIG. 3 depicts a high level flow chart which illustrates an authorized user, such as the owner of the original image, embedding a method in an altered image describing how to reverse the alteration method used to alter the image in accordance with the method and system of the present invention. The process starts as depicted at block 300 and thereafter passes to block 302 which illustrates capturing a visual image utilizing a digital camera. When a visual image is captured, the digital camera will generate digital data which represents the image. The original, unaltered data which represents the original image is stored in the digital camera. Next, block 304 depicts removing either the data which represents the image or a copy of the data from the camera. For example, the image data may be transmitted from the camera to computer system 12. Thereafter, block 306 illustrates selecting an alteration method to use to alter the image data. Many alteration methods are currently known. The color of the original image may be distorted in some manner. Or, for example, the word “PROOF” might be inserted into the digitized image.

Block 308 depicts the alteration of the original image data using the alteration method selected as illustrated by block 306. Thereafter, block 310 depicts the creation of instructions which describe the method necessary to reverse the alteration of the image data. Any user who has access to the instructions will be able to reproduce the original, unaltered image by following the instructions. The process then passes to block 312 which illustrates encrypting the instructions utilizing any known encryption method. In a preferred embodiment, the instructions will be encrypted using industry standard methods such as RSA public/private key. Then, block 314 depicts appending the encrypted instructions to the altered image data. Thereafter, block 316 illustrates storing the altered image data along with the encrypted instructions together in a single electronic file. The process then terminates as depicted by block 318.

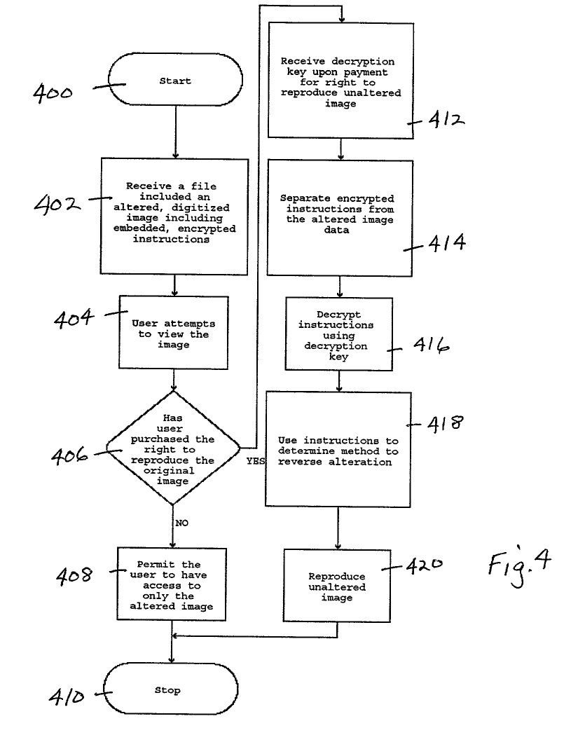

FIG. 4 illustrates a high level flow chart which depicts reproducing original images from the digital proof for only authorized users in accordance with the method and system of the present invention. The process starts as depicted at block 400 and thereafter passes to block 402 which illustrates receiving a digital file which includes an altered image data and encrypted instructions. Thereafter, block 404 depicts permitting the user to attempt to view a digitized image.

Next, block 406 illustrates a determination of whether or not the user has purchased the right to reproduce the original image in its unaltered form. If a determination is made that the user has not purchased the right to reproduce the original image in its unaltered form, the process passes to block 408 which depicts the user being permitted to access only the altered image. The altered image data is utilized to produce the altered image. The process then terminates as illustrated by block 410.

Referring again to block 406, if a determination is made that the user has purchased the right to reproduce the original image in its unaltered form, the process passes to block 412 which depicts the user receiving the decryption key which is necessary in order to decrypt the encrypted instructions. The decryption key is provided to a user upon the payment for the right to reproduce the original, unaltered image. The process passes to block 414 which illustrates separating the encrypted instructions from the altered image data. The altered image data and the encrypted instructions were stored as one single digital file. Once the contents of the file are separated, the process passes to block 416 which depicts decrypting the encrypted instructions using the decryption key received in exchange for the payment. Thereafter, block 418 illustrates using the decrypted instructions to determine the method to use to reverse the alteration of the original image. Next, block 420 depicts reproducing the unaltered, original image for following the instructions. The process then terminates as illustrated by block 410.

While a preferred embodiment has been particularly shown and described, it will be understood by those skilled in the art that various changes in form and detail may be made therein without departing from the spirit and scope of the present invention.

What is claimed is:

1. A method for generating and distributing a digital photographic proof, said method comprising the steps of:
generating an altered image by altering original image data to produce altered image data;
storing said altered image data in an electronic file;
storing encrypted instructions in said file with said altered image data, said instructions describing a method for reversing an alteration method utilized to alter said original image to produce said altered image data;
produce a digital photographic proof utilizing said file by displaying said altered image, wherein all users are permitted to view said altered image; and
permitting only authorized users to utilize said encrypted instructions to reproduce said original image from said altered image data, wherein only authorized users may reproduce said original image, and further wherein said single electronic file is utilized to both produce a digital photographic proof and to reproduce said original image.

2. The method according to claim 1, further comprising the steps of:
providing a decryption key in response to a user purchasing a right to reproduce said original image from said altered image, wherein said user becomes an authorized user in response to said purchase; and
utilizing said decryption key to decrypt said encrypted instructions, wherein only authorized users may decrypt said encrypted instructions.

3. The method according to claim 2, further comprising the step of capturing said original image utilizing a digital camera.

4. The method according to claim 3, further comprising the steps of:
generating said instructions describing said method for reversing said alteration method;
encrypting said instructions;
appending said encrypted instructions to said altered image data; and
storing said encrypted instructions and said altered image together in said file.

5. The method according to claim 3, further comprising the step of storing original image data outside of said camera, said original image data required in order to reproduce said original image.

6. The method according to claim 5, further comprising the steps of:
selecting said alteration method to use to alter said original image data;
altering said original image data to produce said altered image data; and
storing said altered image data in said electronic file.

7. The method according to claim 6, further comprising the steps of:
generating said instructions describing said method for reversing said alteration method;
encrypting said instructions;
appending said encrypted instructions to said altered image data; and
storing said encrypted instructions and said altered image together in said file.

8. The method according to claim 1, further comprising the step of distributing said digital photographic proof in a digital format to a potential purchaser utilizing a floppy diskette.

9. A system for generating and distributing a digital photographic proof, comprising:
means for generating an altered image by altering original image data to produce altered image data;
means for storing said altered image data in an electronic file;
means for storing encrypted instructions in said file with said altered image data, said instructions describing a method for reversing an alteration method utilized to alter said original image to produce said altered image data;
means for produce a digital photographic proof utilizing said file by displaying said altered image, wherein all users are permitted to view said altered image; and
permitting only authorized users to utilize said encrypted instructions to reproduce said original image from said altered image data utilizing said file, wherein only authorized users may reproduce said original image, and further wherein said single electronic file is utilized to both produce a digital photographic proof and to reproduce said original image.

10. The system according to claim 9, further comprising:
means for providing a decryption key in response to a user purchasing a right to produce said original image from said altered image, wherein said user becomes an authorized user in response to said purchase; and
means for utilizing said decryption key to decrypt said encrypted instructions, wherein only authorized users may decrypt said encrypted instructions.

11. The system according to claim 10, further comprising a digital camera for capturing said original image.

12. The system according to claim 11, further comprising:
means for generating said instructions describing said method for reversing said alteration method;
means for encrypting said instructions;
means for appending said encrypted instructions to said altered image data; and
means for storing said encrypted instructions and said altered image together in said file.

13. The system according to claim 11, further comprising means for storing original image data outside of said camera, said original image data required in order to reproduce said original image.

14. The system according to claim 13, further comprising:
means for selecting said alteration method to use to alter said original image data;
means for altering said original image data to produce said altered image data; and
means for storing said altered image data in said electronic file.

15. The system according to claim 14, further comprising:
means for generating said instructions describing said method for reversing said alteration method;
means for encrypting said instructions;
means for appending said encrypted instructions to said altered image data; and
means for storing said encrypted instructions and said altered image together in said file.

16. The system according to claim 9, further comprising a floppy diskette storing said file for distributing said digital photographic proof in a digital format to a potential purchaser.
